(19) United States
(12) Patent Application Publication
(10) Pub. No.: US 2008/0137708 A1
(43) Pub. Date: Jun. 12, 2008

(54) Analytical Method

(76) Inventors: Michael John Quayle, Cumbria (GB); Phillip Stephen Goodall, Cumbria (GB); Steven James Thomson, Cumbria (GB); Neil Cockbain, Cumbria (GB); Timothy Peter Tinsley, Cumbria (GB); Gerard Toon, Cumbria (GB)

Correspondence Address: MOORE & VAN ALLEN PLLC, P.O. BOX 13706, Research Triangle Park, NC, 27709, US

(21) Appl. No.: 11/630,876

(22) PCT Filed: Jul. 1, 2005
(86) PCT No.: PCT/GB05/02578

§ 371 Date: Jan. 23, 2008

(30) Foreign Application Priority Data
Jul. 2, 2004 (GB) 0414809.4

(51) Int. Cl. G01N 25/02

(52) U.S. Cl. 374/17; 374/E11.001

(57) ABSTRACT

The invention provides a method for the determination of the phase change characteristics of a hazardous material, the method comprising optically recording images of a sample of the material and objectively evaluating the images. The phase change characteristics generally relate to a solid/liquid or liquid/solid phase change, and the method finds particular application in the determination of the crystallisation points of hazardous materials, most particularly radioactive materials. The images are typically recorded by means of a camera, and evaluated using a computer, which is able to objectively determine the point at which a phase change is first seen to occur, and thereby provide accurate, reliable and objective data.

### FIELD OF THE INVENTION

The present invention comprises an analytical method which facilitates the accurate determination of the crystallisation point of hazardous materials which present significant practical handling difficulties. More specifically, the method allows for the determination of the crystallisation, dissolution, melting and solidification points of radioactive samples within highly radioactive environments.

### BACKGROUND TO THE INVENTION

The close observation of most non-hazardous materials, in order to carry out accurate determinations of crystallisation, dissolution, melting and solidification points, can generally be achieved by means of straightforward procedures, and is a matter of routine in the field of analytical chemistry. However, the position is very different in the case of many hazardous materials, most particularly radioactive materials, when primary consideration has to be given to health and safety requirements, and the necessity of preventing workers from exposure to, or contact with, the materials. As a consequence, serious handling difficulties are encountered, and the ability to perform many standard analytical determinations with the required degree of accuracy is severely curtailed.

Previous work with radioactive materials in highly radioactive environments concerning the determination of crystallisation points, and related data such as dissolution, melting and solidification points, has relied on the introduction of a radioactive liquor into a hot cell, and the subsequent observation of the cell and contents during the cooling process from a safe distance by, for example, an operative employing a pair of binoculars.

Clearly, such a procedure is highly subjective, and is not designed to provide data with a high degree of accuracy or reliability. The results will be subject to variation in accordance with such factors as the eyesight and personal judgement of the individual, as well as being reliant on the efficiency of the binoculars and their ability to provide appropriate data despite their significant physical separation from the material under investigation. There will, therefore, be great difficulty in comparing different sets of data, and in determining absolute values for the various parameters of different systems. In addition, there will, of course, be the usual experimental limitations associated with measurements involving the accurate determination of temperatures, and the requirement to provide controlled heating or cooling conditions.

The present invention seeks to address the difficulties associated with this prior art approach and to provide a method for the determination of crystallisation points, and related parameters, which is less reliant on such a subjective and inherently unreliable method of observation. The approach employed involves a greater reliance on objective observation and measurement of the systems, and allows for the determination of data by a means which is consistently reliable and repeatable, and allows for the determination of absolute values for different systems with a high degree of accuracy.

### STATEMENTS OF INVENTION

Thus, according to the present invention, there is provided a method for the determination of the phase change characteristics of a hazardous material, said method comprising optically recording images of a sample of the said material and objectively evaluating said images.

The phase change characteristics generally relate to a solid/liquid or liquid/solid phase change, and the method finds particular application in the determination of the crystallisation points of hazardous materials, and is equally applicable to the measurement of the dissolution, melting and solidification points of the said materials.

In the case of homogeneous samples, the method may be used for the determination of melting and solidification points whereas, with heterogeneous solvent/solute mixtures of materials, it is possible to obtain accurate measurements of temperatures of dissolution and crystallisation. Thus, the method displays great versatility and has the potential for wide applicability across a large range of hazardous materials.

The images of the sample are typically recorded by means of a camera, which is focused on the sample, but is stationed at a remote location. Evaluation of the recorded images is then generally performed by means of a computer, which is able to objectively determine the point at which a phase change, such as crystallisation of the sample, is first seen to occur.

### DESCRIPTION OF THE INVENTION

The hazardous materials which may be evaluated by means of the method of the invention encompass a wide variety of such materials, but the method finds particular application with radioactive materials.

The method of the invention is most suitably carried out by introducing the material to be evaluated into an isolated container, the temperature of which can be accurately controlled, such that a selected heating or cooling cycle can be applied, as appropriate. The container can be readily observed by the camera, positioned in a remote location, such that images of the material can be recorded.

In the case of radioactive materials, the container is typically located within a so-called HA cell, specifically designed for the containment of highly radioactive materials.

The container generally holds a small amount of the material to be evaluated, the volume not exceeding 20 ml in the liquid state. Preferably, the volume of material in the container is in the region of 5-15 ml, most preferably about 10 ml.

The material may be introduced into the container in a liquid state and subjected to observation under controlled cooling conditions. However, in a preferred embodiment of the invention, the material is introduced into the container in the solid state and observed under the influence of a controlled heating cycle, designed to induce melting. It is seen, therefore, that the method of the invention may equally be applied to the determination of crystallisation or solidification points on the one hand and, on the other hand, the measurement of melting and dissolution points.

In a particularly preferred application, the method of the invention is applied to the determination of the crystallisation and re-dissolution points of a heterogeneous solvent/solute mixture, thereby facilitating the establishment of the metastable zone width of the sample. Other potential applications are to the measurement of induction times, and of dissolution rates at fixed temperatures.

The method of the invention allows for the production of high quality images, which may be observed online, or stored for offline viewing. Typically, a remotely located camera produces a rapid series of high contrast black and white images as the temperature of the material under investigation is allowed to fall or, more preferably, is raised. Data from the images is supplied to a computer, and subsequent evaluation of these images by means of a proprietary software program facilitates their interpretation and the production of a graph which shows a very distinctive point of inflexion, this point representing the occurrence of the phase change.

The evaluation of the experimental data in this way ensures that the process is free from human subjectivity and interpretation, with the consequent inevitable error factor associated with such procedures. Thus, by means of the method of the invention, it is possible to obtain accurate, reliable, objective data which, in any event, may be supplemented by the traditional human observation and interpretation of the systems to enable more balanced conclusions to be reached.

1. A method for the determination of the phase change characteristics of a hazardous material, said method comprising optically recording images of a sample of the said material and objectively evaluating said images, wherein said optical recording of said images is carried out by means of a camera which is stationed at a remote location.

2. A method as claimed in claim 1 wherein the phase change characteristics relate to a solid/liquid or liquid/solid phase change.

3. A method as claimed in claim 1 for the determination of at least one of the crystallisation, dissolution, melting and solidification points of hazardous materials.

4. A method as claimed in claim 1 wherein said objective evaluation of said images is performed by means of a computer.

5. A method as claimed in claim 4 wherein said evaluation by means of a computer facilitates the production of a graph showing a point of inflexion at the temperature of the phase change.

6. A method as claimed in claim 1 which comprises introducing the material to be evaluated into an isolated container, the temperature of which can be accurately controlled, such that a selected heating or cooling cycle can be applied.

7. A method as claimed in claim 6 wherein said container holds a volume not exceeding 20 ml of the material to be evaluated.

8. A method as claimed in claim 7 wherein said volume is in the region of 5-15 ml.

9. A method as claimed in claim 8, wherein said volume is about 10 ml.

10. A method as claimed in claim 1 wherein said hazardous material comprises radioactive material.

11. A method as claimed in claim 10 wherein said material is located in a container within a HA cell designed for the containment of highly radioactive material.

12. A method as claimed in claim 1 wherein the material is introduced into the container in a liquid state and observed under controlled cooling conditions to facilitate the determination of crystallisation or solidification points.

13. A method as claimed in claim 1 wherein the material is introduced into the container in the solid state and observed under a controlled heating cycle to facilitate the determination of melting and dissolution points.

14. A method as claimed in claim 1 which is applied to the determination of both the crystallisation and re-dissolution points of a heterogeneous solvent/solute mixture in order to facilitate the establishment of the metastable zone width of the sample.

15. A method as claimed in claim 1 which is applied to the measurement of induction times and of dissolution rates at fixed temperatures.

16. A method as claimed in claim 3 wherein the material is introduced into the container in a liquid state and observed under controlled cooling conditions to facilitate the determination of crystallisation or solidification points.

17. A method as claimed in claim 3 wherein the material is introduced into the container in the solid state and observed under a controlled heating cycle to facilitate the determination of melting and dissolution points.

18. A method as claimed in claim 3 which is applied to the determination of both the crystallisation and re-dissolution points of a heterogeneous solvent/solute mixture in order to facilitate the establishment of the metastable zone width of the sample.

19. A method as claimed in claim 3 which is applied to the measurement of induction times and of dissolution rates at fixed temperatures.
